(19) United States
(12) Patent Application Publication
(10) Pub. No.: US 2008/0128519 A1
(43) Pub. Date: Jun. 5, 2008

(54) SELECTION TARGET FOR POINTER MULTIMEDIA EQUIPMENT

(76) Inventors: Eric Masera, Paris (FR); Santie V. Adelbert, Vincennes (FR); Christophe E. Papin, Bois Colombes (FR); Thierry Lebihen, Bourg La Reine (FR)

Correspondence Address: David A. Novais;Patent Legal Staff, Eastman Kodak Company, 343 State Street, Rochester, NY, 14650-2201, US

(21) Appl. No.: 11/945,476

(22) Filed: Nov. 27, 2007

(30) Foreign Application Priority Data
Dec. 1, 2006 (FR) 0610480

(51) Int. Cl. G06K 19/06

(52) U.S. Cl. 235/494

(57) ABSTRACT

Selection target (100) for portable pointer equipment comprising a first and second data medium, in the form of a visual code (104) and a RFID radiofrequency identification (108) respectively, wherein the first and second data media carry identical data, and wherein the first and second data media are superimposed.

Application to multimedia equipment and to logistics management equipment.

### FIELD OF THE INVENTION

The present invention relates to a selection target for portable pointer equipment. Portable pointer equipment means portable electronic equipment such as a telephone, camera, organizer, or audio equipment, provided with a contactless near-field data reader. In particular such a reader can be a visual code reader or a RFID beacon reader (Radiofrequency Identification).

The invention has applications in the field of multimedia equipment and in particular in the interconnection of portable electronic equipment with other electronic equipment, whether portable or not. More generally, it has applications in all fields of visual code or RFID beacon use, including the logistics field.

### BACKGROUND OF THE INVENTION

Electronic equipment, and in particular, portable equipment offers users the possibility of collecting, exchanging and reproducing a large amount of multimedia data. This can entail data relative to images, sound, voice, text or again to command data or program data. The multiplication of data exchanges between equipment is accompanied by a multiplication of data communication channels. While communication by wire connection seems to be losing out to radio communication, it is now also worthwhile to distinguish between long-distance communication, e.g. by network, local broadband communication, and near-field communication.

Among contactless near-field communication media, there are especially visual codes and RFID beacons.

Generally, RFID beacons comprise an electronic chip and an integrated communications antenna. The antenna can also be used as a power supply loop. Initially, very summary and reserved to the simple role of identification, RFID beacons can now contain data or program instructions. RFID beacons can be read or possibly updated, by means of an adapted reader of portable equipment. Interaction between the equipment provided with the reader and the RFID beacon takes place at a very close distance of about a few millimeters to some tens of centimeters. Interaction is generally started following the remote powering of a RFID beacon by power radiated by the reader, and received by the beacon's antenna.

Another media type of near-field communication is the visual code. The visual code, sometimes erroneously referred to as “barcode”, comprises data encoded in graphic form. These can be bars, dots, small squares, or other patterns, whether colored or not, that also carry data or executable instructions. Barcodes can be read using portable equipment such as phones or cameras provided with a digital image sensor. By capturing at close distance one or more images of a visual code, the data of this code can be decoded and interpreted or used by the reader device.

Whatever near-field communication media is used, RFID beacon or visual code, an important aspect, linked to the minimal reading range, is the possibility of using the portable reading equipment as a pointer. For users, the act of approaching their portable equipment to a very short distance from a RFID beacon or visual code enables the selection of information or instructions from this data medium to the exclusion of data from any other nearby media, and to automatically start the transfer or execution of the data. Thus, the act of pointing to a selection target with portable equipment is comparable to pressing a selection button.

### SUMMARY OF THE INVENTION

RFID beacons are very small and can be inserted in a self-adhesive sheet, in the form of a small adhesive sticker. The same applies to visual codes that can be in the form of a self-adhesive medium. In addition the sticker can bear an inscription or logo visually informing users of the type of data offered or the type of instructions that they can obtain by pointing their equipment at the sticker.

Because of the coexistence of the two technologies, RFID and visual code, users are disturbed by the separation of the available information. This results from a) the fact that the same set of data can be presented by a RFID beacon and by a visual code, and, b) the fact that users are not necessarily informed of the read technology used by their portable equipment.

In particular, users can hesitate in their selection when information is offered both in visual code form and RFID beacon form.

It is the object of the invention to propose a selection target for portable pointer equipment capable of being sighted by users without taking their equipment's technology into account.

It is also an object to propose a target that is compatible with equipment provided with a RFID reader, equipment provided with a visual code reader, or equipment provided with both means.

Yet another object is to improve the reading of information carried by the target.

To achieve these objects, a more precise object of the invention is a selection target intended for pointer electronic equipment. The target comprises a first and second data medium, respectively in the form of a visual code and a local range radiofrequency identifier, in this case a RFID beacon. According to the invention, the first and second data media carry identical data, and the first and second data media are superimposed.

It is assumed that the data of the first and second media are identical when the data read or the instructions obtained by pointer equipment, with optical reader and radio reader, are the same. The identity of the data does not refer to their organization within the medium, but to their contents or function.

The presence of identical data on the first and second media does not however exclude any presence of data specific to each medium.

Furthermore, it is assumed that the data media are superimposed when pointer equipment capable of both radio reading and optical reading cannot selectively capture the data from one of the media without also capturing the data of the other medium.

The data stored in the first and second medium can in particular comprise information data and program data, i.e. data or instructions executable by the pointer equipment or by other equipment in communication with the pointer equipment. The information data can especially comprise electronic addresses (URL), or display content data. Program data can comprise instructions for pairing the pointer equipment with host equipment.

The first medium, carrying the visual code, can be in the form of a display screen for displaying the visual code. It can also be a medium carrying a permanent printing of the visual code.

If the first medium is a display screen, the second medium, the radiofrequency beacon in this case, can be integrated in the screen or applied to the screen. In the last case, the second medium is preferably transparent.

Thus, the invention also relates to a process of forming a selection target, as described previously, comprising the display of a visual code in a region of a display screen carrying a RFID beacon, so that the visual code and the beacon are superimposed.

Other characteristics and advantages of the invention will appear in the following description, which refers to the figures of the appended drawings. This description is given purely as an illustration and is not limiting.

### BRIEF DESCRIPTION OF THE DRAWINGS

FIG. 1 illustrates the use possibilities of selection targets for host equipment.

FIG. 2 is a schematic representation of a selection target according to the invention.

### DETAILED DESCRIPTION OF THE INVENTION

For purposes of clarity, the figures are represented with no set scale. The relative size of the elements represented is thus not significant.

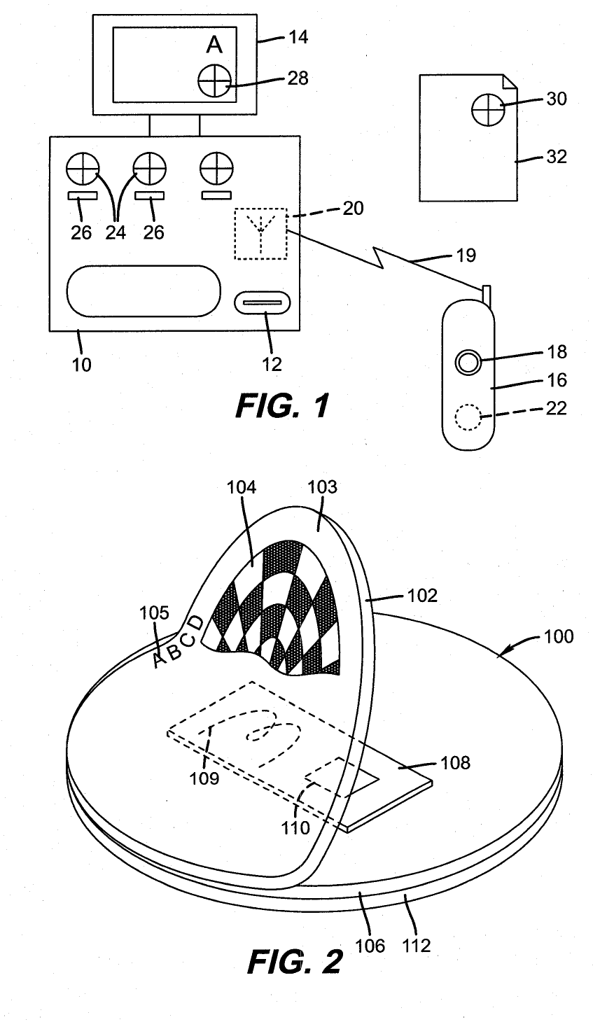

FIG. 1 shows a public printer 10, still designated as “kiosk”, on which users can, on a self-service basis, produce prints of digital images. Such a printer generally has an interface 12 where users can insert memory cards or other digital media which carry image data. An interactive screen 14 gives users a preview of the images they supply the machine with and lets them select those that are to be printed. The interactive screen also enables the selection of the printing characteristics, e.g. the number and format of the prints, and possibly some retouching of the images.

The digital images can also be transmitted directly from a camera to the printer, using a local radio communication channel. This is, for example, a Bluetooth or WiFi type local communications network 19. The figure shows a mobile phone 16 provided with a camera 18 and provided with such a local transmitter/receiver. The printer also comprises a local network transmitter/receiver. It is shown schematically by an antenna with broken lines 20. The local network communications channel can be used to transfer the image data and also executable instructions to the printer. Data can also be received from the printer.

In the example of the figure, the mobile phone, which here represents pointer equipment according to the invention, is provided with a reader-decoder of visual codes. This is capable of decoding visual codes or “barcodes” captured by means of the camera 18. It also comprises a reader 22 of RFID beacons. The reader 22 of RFID beacons can communicate automatically with beacons as soon as the phone is moved to within a few centimeters of them. The RFID reader like any camera can be operated by a program of the mobile phone.

The public printer 10 has on an external surface of its cover, facing the users, several selection targets 24 according to the invention that each have a RFID beacon and a visual code. A sticker 26 giving its function is combined with each target.

For example, a first target 24 can correspond to uploading image data to the printer and their printing. A second target can correspond with uploading image data to the printer for routing them by communication networks to a storage server. Yet another target can correspond to large size printing of all or part of the prints. This list of examples is of course not limiting.

The reading of a target by the pointer equipment is followed by the decoding of the data it contains, whatever reading means is used. The data comprise, in the illustrated case, instructions enabling the pointer equipment to make automatic radio communication with the printer, by means of the local network 19, transfer the image data and transfer an instruction corresponding to the selected target. The instruction can be in program form or in the form of a code starting a program already present in the printer. It corresponds to functions of printing, data storage, payment or some other service offered by the public printer.

The result of the selection is that same whether the pointer equipment has read the visual code, RFID beacon or both at once. A temporary blocking mechanism, implemented on the reader, can be planned to prevent repetition of command execution when two different readings of the same target are not perfectly concomitant.

As FIG. 1 shows with reference 28, the target, or more precisely the target's visual code can also be displayed on the display screen 14. In this case, the visual code is displayed in a zone of the screen in which a RFID beacon is also found. The RFID beacon can be integrated in the screen or more simply be integrated in a self-adhesive and transparent sticker applied to the screen. The target is only formed when the visual code is displayed. Its content can be variable. However, in this case, the RFID beacon is a beacon whose contents can be updated so as to carry the same data as the screen. The update can take place using a beacon read/write device, integrated or not with the printer, with each modification of the visual code data.

The target 28 whose contents are displayed on screen can correspond, for example to a promotional offer or to an option appearing with the instruction of an order.

A target 30, according to the invention can also be formed by printing a visual code on a sheet of paper 32 with a RFID beacon set in the thickness. It can also be formed by affixing a transparent sticker containing a beacon onto the printed visual code.

It is worth saying that the invention is not limited just to public printers, or even to domestic printers. It can be adapted to any type of host equipment and more generally to any type of medium simply by affixing a target to it.

The data or instructions read by the portable pointer equipment can be used or executed by the pointer equipment, by the host equipment carrying the target, or again by other equipment in communication with the pointer equipment.

FIG. 2 shows a particular embodiment of a target 100 according to the invention. The target has three parts.

A first sheet 102 has a main external surface 103 comprising a visual code 104 and a summary inscription 105 relating to the target. The inscription can be simply an advertising inscription or an inscription descriptive of a service or work capable of being executed in response to reading the target.

The first sheet covers a second sheet 106 comprising a RFID beacon 108 provided with an antenna 109 and a chip 110. The beacon can be set in the second sheet or be laid on it. The chip contains, for example, the electronic address 10 of the host equipment to which it is destined. It can also contain advertising data, or, in the way previously described, executable instructions. These data or instructions are identical to those encoded in the visual code 104.

Finally, a self-adhesive sticker layer 112 is planned on the main surface of the target opposite that carrying the visual code.

It may be seen that the target of FIG. 2 has the form of a sticker in which the visual code and RFID beacon cover one another. The order of the different layers can be modified. The adhesive layer 112 can cover the sheet 102 carrying the visual code, for application on a transparent medium, such as a showcase. Furthermore, the sheet 106 comprising the beacon can also be above the sheet carrying the visual code, so long as it is transparent.

The target can also comprise a single medium containing the beacon, and presenting the visual code.

Finally, the medium can be transparent and lacking a visual code. Then, as mentioned above, it can be stuck onto another medium onto which the visual code has previously been printed.

The invention has been described in detail with particular reference to certain preferred embodiments thereof, but it will be understood that variations and modifications can be effected within the spirit and scope of the invention.

1. Selection target (100) for portable pointer equipment comprising a first and second data medium, in the form of a visual code (104) and a RFID radiofrequency beacon (108) respectively, wherein the first and second data media carry identical data, and wherein the first and second data media are superimposed.

2. The target according to claim 1, wherein the first data medium comprises a display screen (14) to display the visual code.

3. The target according to claim 1, wherein the first data medium comprises a permanent printing of the visual code.

4. The target according to claim 1, wherein at least one of the first and second media is transparent.

5. The target according to claim 1, comprising a sheet (106), integrating the radiofrequency beacon, and having a first main surface (103) carrying a printing of the visual code (104).

6. The target according to claim 5, comprising on a second main surface, opposite the first main surface, an adhesive layer (112).

7. The target according to claim 1, wherein the data are instructions for pairing the pointer equipment with host equipment.

8. Host multimedia equipment comprising a target according to claim 1.

9. Process of forming a selection target according to claim 1, comprising the display of the visual code in a region of a display screen carrying the RFID beacon.

10. The process according to claim 9, comprising the update of the RFID beacon data, with each modification of the visual code data.
